(19) United States
(12) Patent Application Publication
(10) Pub. No.: US 2011/0243363 A1
(43) Pub. Date: Oct. 6, 2011

(54) SPEAKER

(75) Inventor: SHIN YAMAGUCHI, Kanagawa (JP)

(73) Assignee: Sony Corporation, Tokyo (JP)

(21) Appl. No.: 13/070,898

(22) Filed: Mar. 24, 2011

(30) Foreign Application Priority Data
Mar. 30, 2010 (JP) 2010-077729

(51) Int. Cl. H04R 1/02

(52) U.S. Cl. 381/386

(57) ABSTRACT

A speaker is provided with a support base provided with a connection portion which has an inclined surface inclined at a predetermined angle relative to a horizontal direction, a connector which has a sloping surface inclined at the same angle as the inclined surface of the support base relative to the horizontal direction and is provided with a joining portion connected to the connection portion of the support base in a state where the sloping surface comes into contact with the inclined surface, and a main body which is attached to the connector and has a sound output portion, where the main body is inclined in at least two states of a first inclined state and a second inclined state with different inclined angles relative to a vertical direction according to an orientation whereby the joining portion of the connector is connected to the connection portion of the support base.

### BACKGROUND OF THE INVENTION

1. Field of the Invention

The present invention relates to a speaker. Specifically, the invention relates to a speaker which secures a necessary inclined state of a main body which is achieved with a simplified mechanism by the main body being inclined at a different inclined angle according to the orientation whereby a joining portion of a connector is connected to a connection portion of a support base.

2. Description of the Related Art

As a speaker, for example, there are speakers provided with disk playback devices and speakers used while disposed at the side of a television or the like.

For example, in regard to televisions, in a state of being placed on a placement surface such as the floor due to an increase in size in recent years, by inclining the screen slightly upwards, images and video displayed on the screen are easier to view. Accordingly, in regard to speakers used while disposed at the side of a television, the speakers are often placed on the placement surface with the same inclined angle corresponding to the inclined angle of the screen of the television.

As a means for placing such a speaker in an inclined state, for example, legs are provided for inclining the placement base provided at the lower end of the speaker.

Additionally, as a means for inclining the structure, there is also a means with a configuration where a plurality of parts is provided which are arranged by being overlapped in the up/down direction and the plurality of parts are able to rotate each other in a horizontal direction and which inclines using the rotation of each part (for example, Japanese Unexamined Utility Model Registration Application Publication No. 7-18208).

### SUMMARY OF THE INVENTION

However, in a speaker which is inclined by being provided with leg portions in a placement base there are problems in that, since the placement base in inclined in relation to the placement surface, it is inclined in an unstable state and manufacturing costs increase due to the provision of the legs as separate parts increases the number of parts.

Additionally, in the means described in Japanese Unexamined Utility Model Registration Application Publication No. 7-18208, there are problems in that, since the number of parts arranged by being overlapped in the up/down direction is large and there is a configuration where the plurality of parts are able to rotate each other, the structure is complicated and manufacturing costs are high as the number of parts is large.

Therefore, it is desirable to provide a speaker that overcomes the problems described above and secures a necessary inclined state of a main body which is achieved with a simplified mechanism.

According to an embodiment of the present invention, there is provided a speaker including a support base provided with a connection portion which has an inclined surface inclined at a predetermined angle relative to a horizontal direction, a connector which has a sloping surface inclined at the same angle as the inclined surface of the support base relative to the horizontal direction and is provided with a joining portion connected to the connection portion of the support base in a state where the sloping surface comes into contact with the inclined surface, and a main body which is attached to the connector and has a sound output portion, where the main body is inclined in at least two states of a first inclined state and a second inclined state with different inclined angles relative to the vertical direction according to the orientation whereby the joining portion of the connector is connected to the connection portion of the support base.

Accordingly, in the speaker, the main body is inclined at different inclined angles according to the orientation of the joining portion connected to the connection portion.

In regard to the speaker described above, it is desirable if the joining portion of the connector is able to rotate in the horizontal direction in relation to the connection portion of the support base, and in a state where the joining portion of the connector is connected to the connection portion of the support base, the main body is inclined at different inclined angles according to the rotation position due to the rotation of the connector in relation to the support base.

The main body is inclined at different inclined angles according to the rotation position of the joining portion in relation to the connection portion by the main body being inclined at different inclined angles according to the rotation position due to the rotation of the connector in relation to the support base.

In regard to the speaker described above, it is desirable if an inclined angle of the first inclined state is set to 0°.

The main body is in a vertical state in the first inclined state by setting the inclined angle of the first inclined state to 0°.

In regard to the speaker described above, it is desirable if the joining portion and the connection portion are connected in an orientation whereby the inclined surface of the support base and the sloping surface of the connector come into contact in a state where the inclined directions are 180° in opposite directions in the horizontal direction, and the main body is inclined in the first inclined state.

The inclined surface and the sloping surface come into contact in a state of being in opposite directions and the main body is in a vertical state by the joining portion and the connection portion being connected in an orientation whereby the inclined surface and the sloping surface come into contact in a state where the inclined directions are 180° in opposite directions in the horizontal direction, and the main body is inclined in the first inclined state.

In regard to the speaker described above, it is desirable if a lock concave portion is formed on one out of the connection portion of the support base and the joining portion of the connector and a lock protrusion portion which engages with the lock concave portion is provided in the other, and the lock protrusion portion engages with the lock concave portion to lock the main body in the first inclined state or the second inclined state.

The main body is maintained in the first inclined state or the second inclined state by engaging the lock protrusion portion with the lock concave portion to lock the main body in the first inclined state or the second inclined state.

A speaker of an embodiment of the invention is provided with a support base provided with a connection portion which has an inclined surface inclined at a predetermined angle relative to a horizontal direction, a connector which has a sloping surface inclined at the same angle as the inclined surface of the support base relative to the horizontal direction and is provided with a joining portion connected to the connection portion of the support base in a state where the sloping surface comes into contact with the inclined surface, and a main body which is attached to the connector and has a sound output portion, and the main body is inclined in at least two states of a first inclined state and a second inclined state with different inclined angles relative to a vertical direction according to an orientation whereby the joining portion of the connector is connected to the connection portion of the support base.

Accordingly, it is possible to secure a necessary inclined state of a main body which is achieved with a simplified mechanism.

In a speaker of another embodiment of the invention, the joining portion of the connector is able to rotate in the horizontal direction in relation to the connection portion of the support base, and in a state where the joining portion of the connector is connected to the connection portion of the support base, the main body is inclined at different inclined angles according to a rotation position due to the rotation of the connector in relation to the support base.

Accordingly, it is possible to simply perform changing of the inclined state of the main body, and it is possible to achieve an improvement in usability.

In a speaker of still another embodiment of the invention, an inclined angle of the first inclined state is set to 0°.

Accordingly, it is possible to secure a stable supporting state of the main body in the first inclined state.

In a speaker of still another embodiment of the invention, the joining portion is connected to the connection portion in an orientation whereby the inclined surface of the support base and the sloping surface of the connector come into contact in a state where the inclined directions are 180° in opposite directions in the horizontal direction, and the main body is inclined in the first inclined state.

Accordingly, a mechanism, which inclines the main body in the first inclined state where the inclined angle is 0° relative to the vertical direction, is simple and it is possible to achieve a reduction in manufacturing costs due to the simplification of the mechanism.

In a speaker of still another embodiment of the invention, a lock concave portion is formed in one out of the connection portion of the support base and the joining portion of the connector and a lock protrusion portion which engages with the lock concave portion is provided in the other, and the lock protrusion portion engages with the lock concave portion to lock the main body in the first inclined state or the second inclined state.

Accordingly, it is possible to reliably support the main body in the first inclined state or the second inclined state using a simple mechanism.

### BRIEF DESCRIPTION OF THE DRAWINGS

FIG. 1 is a perspective diagram illustrating a speaker with a television, and along with FIGS. 2 to 6, illustrates a speaker according to a first embodiment of the invention;

FIG. 2 is an exploded perspective diagram of the speaker;

FIG. 3 is an exploded cross-sectional diagram of the speaker;

FIG. 4 is a perspective diagram of a connector;

FIG. 5 is a cross-sectional diagram illustrating a first inclined state;

FIG. 6 is a cross-sectional diagram illustrating a second inclined state;

FIG. 7 is an exploded perspective diagram of a speaker, and along with FIGS. 8 to 10, illustrates a speaker according to a second embodiment of the invention;

FIG. 8 is an exploded cross-sectional diagram of the speaker;

FIG. 9 is a cross-sectional diagram illustrating a first inclined state; and

FIG. 10 is a cross-sectional diagram illustrating a second inclined state.

### DESCRIPTION OF THE PREFERRED EMBODIMENTS

Below, a speaker according to an embodiment of the invention will be described in accordance with the attached diagrams.

### First Embodiment

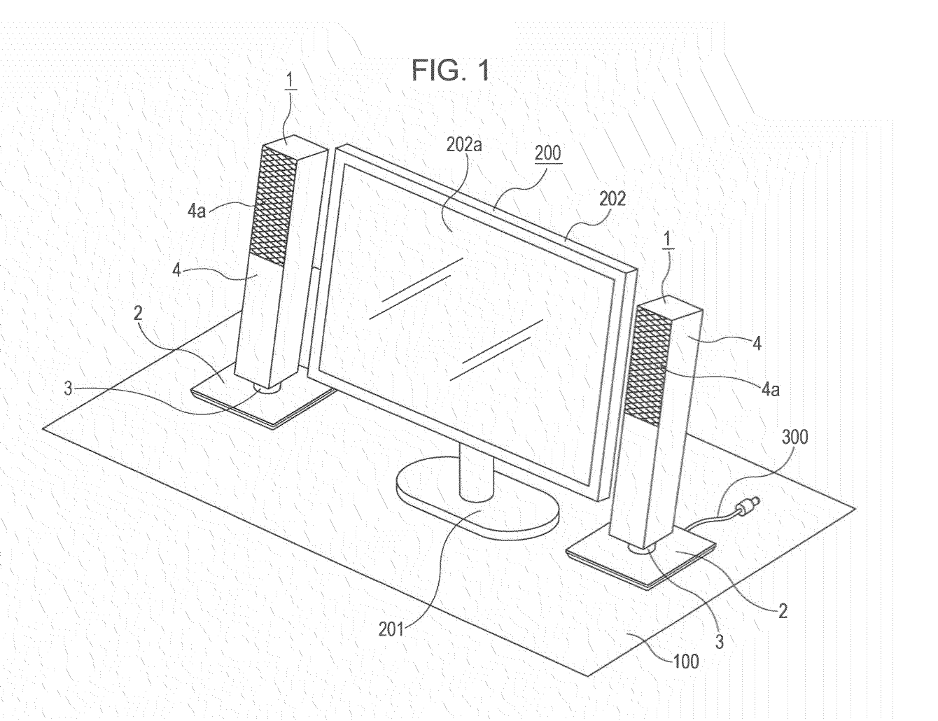

Firstly, a speaker 1 according to a first embodiment will be described (refer to FIGS. 1 to 6).

### Speaker Structure

The speaker 1 is provided a support base 2, a connector 3, and a main body 4 (refer to FIG. 1). The speaker 1 is connected to a television 200 placed on a placement surface 100 such as the floor via a cable 300 and is placed on the placement surface 100 at a side of the television 200. The television 200 has a stand 201 and a display portion 202 supported so as to be able to be inclined by the stand 201. By inclining the display portion 202 in relation to the stand 201, it is possible to set an arbitrary state of inclination from a state where a screen 202a faces forward until a state where the screen 202a faces slightly diagonally upward. The speaker 1 outputs the sound of the television 200.

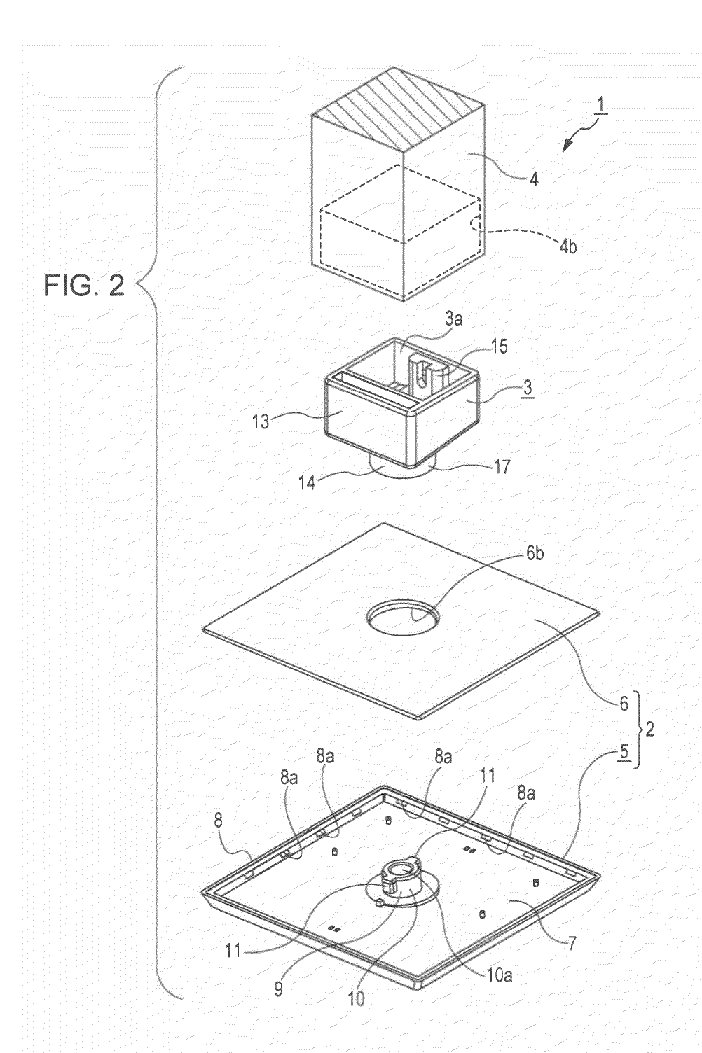

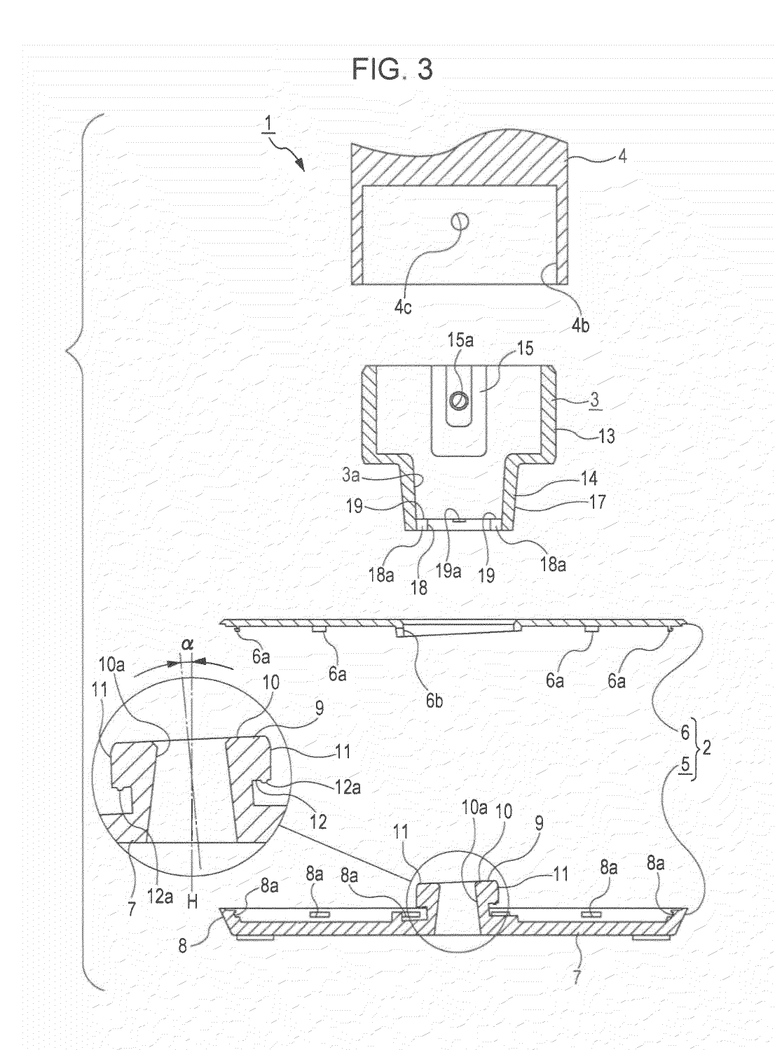

The support base 2 has a placement base 5 and a cover 6 (refer to FIGS. 2 and 3).

The placement base 5 is formed by the integral formation of a placement surface portion 7 formed in a rectangular plate shape facing in the up/down direction, a periphery surface portion 8 which protrudes substantially upwards from a periphery portion of the placement surface portion 7, and a connection portion 9 which protrudes upwards from a central portion of the placement surface portion 7.

In an inner surface of the periphery portion 8, a plurality of engagement concave portions 8a, 8a, . . . are formed which are spaced apart in a circumference direction.

The connection portion 9 is formed from an axial portion 10 with a substantially cylindrical shape which protrudes upward from the placement surface portion 7 and connection protrusions 11 and 11 which protrude in opposite directions to each other from a periphery surface of the axial portion 10. The connection portion 9 is provided in a state of being inclined by a predetermined angle α such as 3° relative to a vertical direction H (refer to FIG. 3).

In the axial portion 10, a cable extraction hole 10a is formed which passes therethrough in the up/down direction.

The connection protrusions 11 and 11 are positioned above the upper end of the periphery surface portion 8. A lower surface of the connection protrusions 11 and 11 are formed as inclined surfaces 12 and 12 which are inclined relative to the horizontal direction at, for example, 3°, and in the inclined surfaces 12 and 12, lock protrusion portions 12a and 12a are provided which each protrude downward.

The cover 6 is formed in a rectangular flat plate shape facing in the up/down direction. In a periphery portion of a lower surface of the cover 6, a plurality of engagement protrusion portions 6a, 6a, . . . are provided which are spaced apart in the circumference direction. In a central portion of the cover 6, a cable insertion hole 6b is formed.

The cover 6 is connected to the support base 5 by the engagement protrusion portions 6a, 6a, . . . respectively engaging with the concave engagement portions 8a, 8a, . . . of the periphery portion 8.

As shown in FIGS. 2 to 4, the connector 3 is formed by the integral formation of an insertion alignment portion 13 where the outer shape is formed in a rectangular parallelepiped shape and a joining portion 14 which protrudes downward from the insertion alignment portion 13 and where the outer shape is formed in a tapered cylindrical shape. In the connector 3, a insertion hole 3a is formed which passes therethrough in the up/down direction.

At a side of an inner portion of the insertion alignment portion 13, an attachment portion 15 is provided and a screw insertion hole 15a is formed which passes through the attachment portion 15 in the horizontal direction (refer to FIGS. 2 and 3). In an inner portion of the attachment portion 15, a nut 16 is arranged and a central axis of a screw hole 16a of the nut 16 matches a central axis of a screw insertion hole 15a.

The joining portion 14 is formed from a circumference portion 17 formed with a substantially cylindrical shape and an extrusion portion 18 which extrudes to an inner side from a lower end portion of the circumference portion 17.

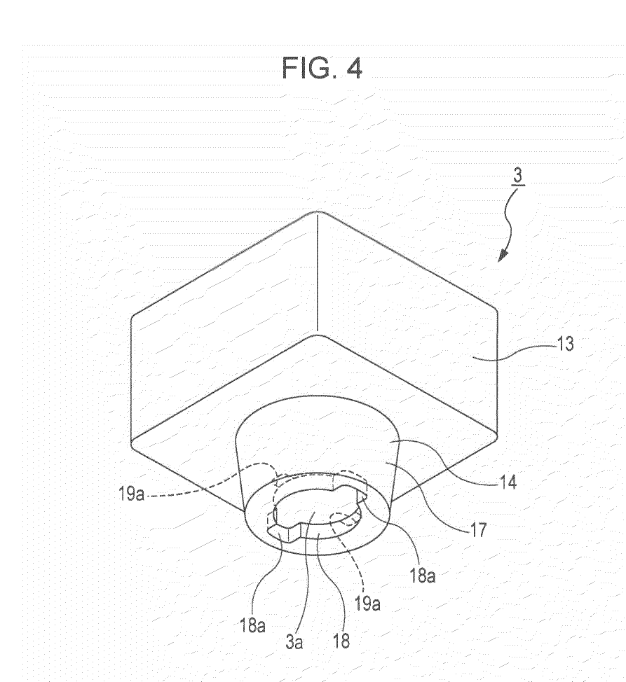

In the extrusion portion 18, insertion cutouts 18a and 18a are formed which open out in directions which face each other at positions which are 180° opposed to each other in the circumference direction (refer to FIGS. 3 and 4). An upper surface of the extrusion portion 18 is formed as sloping surfaces 19 and 19 which are inclined relative to the horizontal direction at, for example, 3°, and in the sloping surfaces 19 and 19, lock concave portions 19a and 19a are formed which open out upwardly and are positioned on sides which are 180° opposite in the horizontal direction.

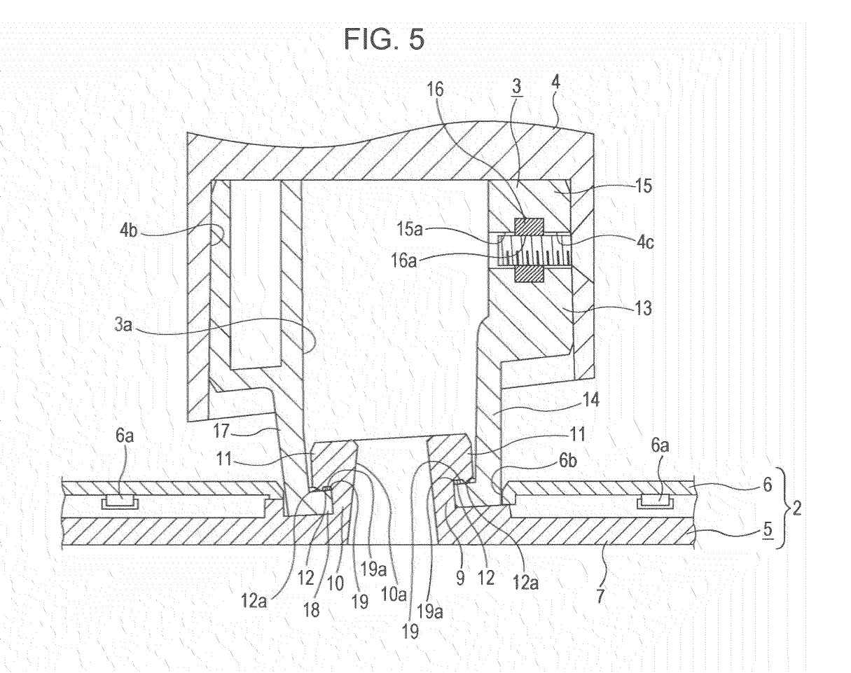

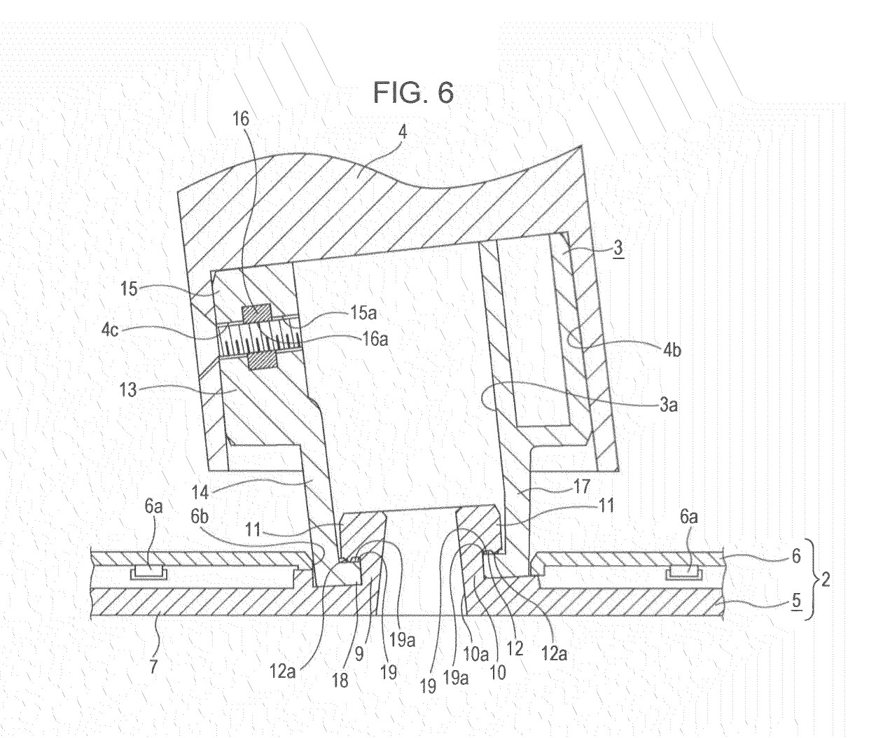

The connector 3 is connected to the support base 2 by the joining portion 14 being inserted into the cable insertion hole 6b of the cover 6 from above, the connection protrusion portions 11 and 11 being respectively inserted into the insertion cutouts 18a and 18a of the extrusion portion 18, being rotated in the horizontal direction, and the sloping surfaces 19 and 19 respectively coming into contact with the inclined surfaces 12 and 12 of the connection protrusion portions 11 and 11 (refer to FIGS. 5 and 6).

The main body 4 is, for example, formed in a cylindrical shape which is long in the up/down direction and is provided with sound output portions 4a and 4a in at least two side surfaces positioned on sides which are 180° opposite (refer to FIG. 1). In a lower end portion of the main body 4, an attachment concave portion 4b is provided which opens out in a downward direction (refer to FIGS. 2 and 3). In a position toward a lower end of the main body 4, an attachment hole 4c is formed which connects an outer circumference surface and the attachment concave portion 4b.

The main body 4 is attached to the connector 3 by the insertion alignment portion 13 being inserted into the attachment concave portion 4b, an attachment screw 400 being inserted into the attachment hole 4c and the screw insertion hole 15a of the insertion alignment portion 13, and being screwed into the screw hole 16a of the nut 16 (refer to FIGS. 5 and 6).

In a state where the speaker 1 is configured by the support base 2, the connector 3, and the main body 4 being connected as described above, one end of the cable 300 is connected to a connection portion (not shown) in an inner portion of the main body 4, is passed through the insertion hole 3a of the connector 3, the cable insertion hole 6b of the support base 2, and the cable extraction hole 10a of the support base 2 in order, and the other end of the cable 300 is led out to the outside and is connected to an external terminal (not shown) of the television 200.

### Speaker Formation

In the speaker 1 configured in such a manner, when the connector 3 and the main body 4 are integrated and rotated in the horizontal direction in relation to the support base 2 with the connection portion 9 as a support axis, the main body 4 is inclined in a state of either a first inclined state or a second inclined state according to a rotation position of the connector 3.

For example, when the connector 3 is rotated in relation to the support base 2 until a position where the inclined direction of the inclined surfaces 12 and 12 of the support base 2 and the inclined direction of the sloping surfaces 19 and 19 of the connector 3 become directions which are 180° in opposite directions relative to the horizontal direction, the first inclined state of the main body 4 is set and the main body 4 is in a state inclined by 0° relative to the vertical direction, that is, is in a vertical state (refer to FIG. 5).

At this time, by the lock protrusion portions 12a and 12a provided in the inclined surfaces 12 and 12 of the support base 2 respectively engaging with the lock concave portions 19a and 19a formed in the sloping surfaces 19 and 19 of the connector 3, the connector 3 is locked in relation to the support base 2 and the main body 4 is maintained in the first inclined state.

Additionally, when the connector 3 is rotated in relation to the support base 2 until a position where the inclined direction of the inclined surfaces 12 and 12 of the support base 2 and the inclined direction of the sloping surfaces 19 and 19 of the connector 3 become directions which are the same in the horizontal direction, the second inclined state of the main body 4 is set and the main body 4 is in a state inclined by 6° relative to the vertical direction (refer to FIG. 6).

At this time, by the lock protrusion portions 12a and 12a provided in the inclined surfaces 12 and 12 of the support base 2 respectively engaging with the lock concave portions 19a and 19a formed in the sloping surfaces 19 and 19 of the connector 3, the connector 3 is locked in relation to the support base 2 and the main body 4 is maintained in the second inclined state.

As described above, in the speaker 1, the main body 4 is inclined in a state of either the first inclined state or the second inclined state with different inclined angles relative to the vertical direction according to an orientation whereby the joining portion 14 of the connector 3 is connected to the connection portion 9 of the support base 2.

Accordingly, it is possible to secure a necessary inclined state of the main body 4 which is achieved with a simplified mechanism.

Additionally, since the main body 4 is inclined in the first inclined state or the second inclined state according to the rotation position due to the rotation of the connector 3 in relation to the support base 2, it is possible to simply perform changing of the inclined state of the main body 4 and it is possible to achieve an improvement in usability.

Furthermore, since the inclined angle of the first inclined state is set to 0° where there is no inclination relative to the vertical direction, it is possible to secure a stable supporting state of the main body 4 in the first inclined state. In addition, by setting the inclined angle of the first inclined state to 0°, the angle, which is used as a standard relative to the vertical direction, is made clear.

In addition, in the description above, an example is shown where the inclined angle of the first inclined state relative to the vertical direction is set to 0° and the inclined angle of the second inclined state relative to the vertical direction is set to 6°. However, it is possible to set the inclined angles of the first inclined state and the second inclined state relative to the vertical direction to arbitrary angles other than 0° or 6°.

For example, it is possible to set the inclined angle of the inclined surfaces 12 and 12 of the support base 2 and the sloping surfaces 19 and 19 of the connector 3 relative to the horizontal direction to n° (where n° is an arbitrary number larger than 0), to set the first inclined state (0°) by setting the inclined direction of the inclined surfaces 12 and 12 and the inclined direction of the sloping surfaces 19 and 19 of the connector 3 as directions which are 180° in opposite directions relative to the horizontal direction, and to set the second inclined state (2n°) by setting the inclined direction of the inclined surfaces 12 and 12 and the sloping surfaces 19 and 19 as directions which are the same.

Additionally, in the speaker 1, the inclined state of the main body 4 is not limited to the two inclined states of the first inclined state and the second inclined state, it is possible to have a configuration where three or more inclined states are set according to the rotation position of the connector 3 in relation to the support base 2.

In the speaker 1, by the joining portion 14 being connected to the connection portion 9 with an orientation whereby the inclined surfaces 12 and 12 of the support base 2 and the sloping surfaces 19 and 19 of the connector 3 come in contact in a state where the inclined directions are 180° in opposite directions relative to the horizontal direction, the main body 4 is inclined in the first inclined state.

Accordingly, a mechanism, which inclines the main body 4 in the first inclined state where the inclined angle is 0° relative to the vertical direction, is simple and it is possible to achieve a reduction in manufacturing costs due to the simplification of the mechanism.

Additionally, in the speaker 1, the main body 4 is maintained in the first inclined state or the second inclined state by the lock protrusion portions 12a and 12a being provided in the support base 2 and the lock concave portions 19a and 19a which respectively engage with the lock protrusion portions 12a and 12a being formed in the connector 3.

Accordingly, it is possible to reliably support the main body 4 in the first inclined state or the second inclined state using a simple mechanism.

In addition, in the description above, an example is shown where the lock protrusion portions 12a and 12a are provided in the support base 2 and the lock concave portions 19a and 19a are formed in the connector 3. However, on the contrary, lock concave portions may be formed in the support base 2 and lock protrusion portions may be provided in the connector 3.

### Second Embodiment

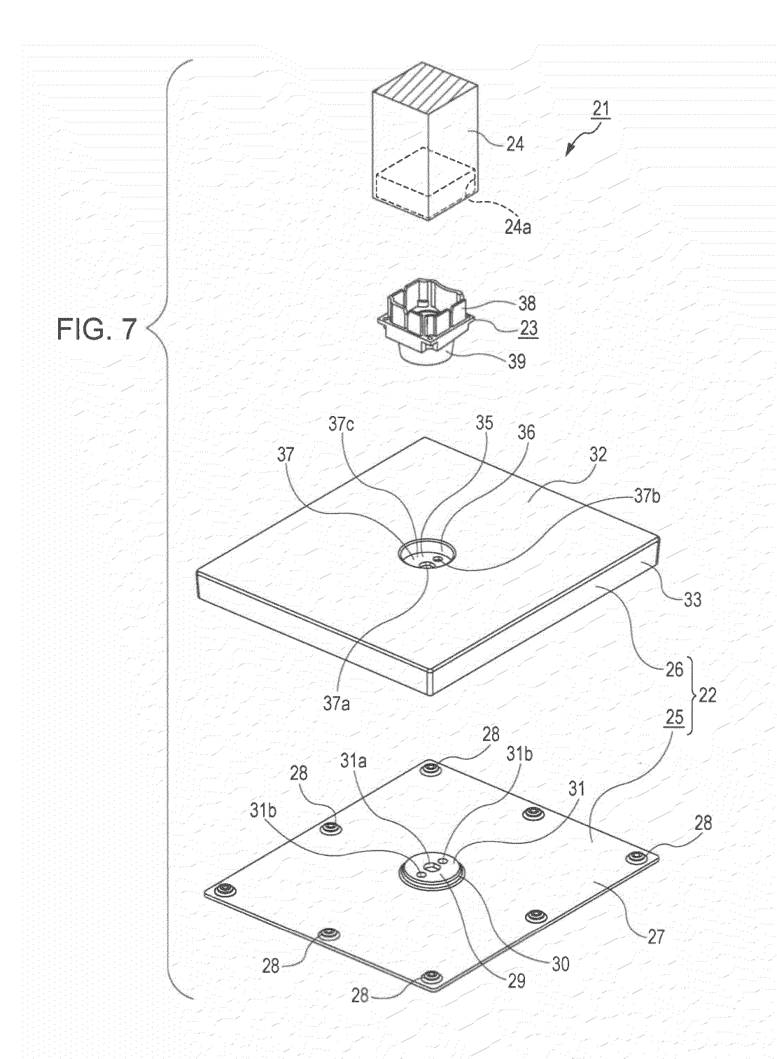

Next, a speaker 21 according to a second embodiment will be described (refer to FIGS. 7 to 10).

### Speaker Structure

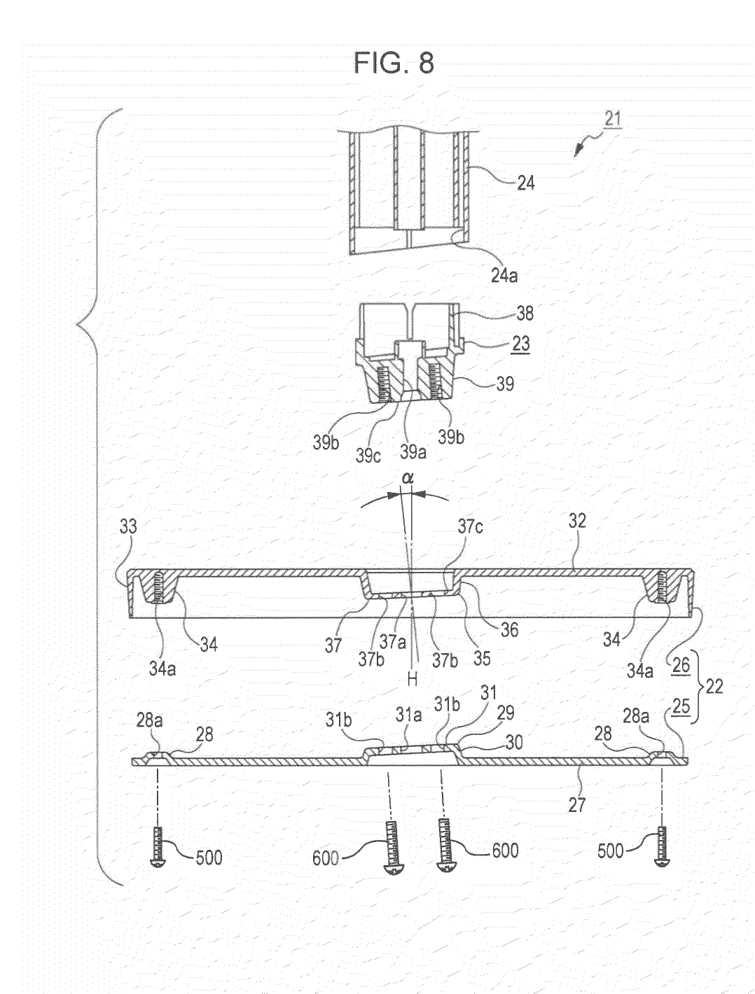

The speaker 21 is provided a support base 22, a connector 23, and a main body 24 (refer to FIGS. 7 and 8). The speaker 21 is also connected to a television placed on a placement surface such as the floor in the same manner as the speaker 1.

The support base 22 has a placement base 25 and a cover 26.

The placement base 25 is formed by the integral formation of a placement surface portion 27 formed in a rectangular plate shape facing in the up/down direction, attachment protrusion portions 28, 28, . . . which are provided in a periphery portion of the placement surface portion 27 spaced apart in the circumference direction and protrude upwards, and a protrusion portion 29 which protrudes upwards from a central portion of the placement surface portion 27 in a hammered out shape.

In the attachment protrusion portions 28, 28, . . . , screw holes 28a, 28a, . . . are respectively formed.

The protrusion portion 29 is formed from a periphery surface portion 30, which is continuous with the placement surface portion 27 and is formed in a substantially cylindrical shape, and a top surface portion 31 which is continuous with an upper end portion of the periphery surface portion 30.

The top surface portion 31 is provided in a state of being inclined relative to the horizontal direction at, for example, 3°. In the top surface portion 31, a cable extraction hole 31a is formed in a central portion and screw insertion holes 31b and 31b are formed on both sides of the cable extraction hole 31a.

The cover 26 is formed by the integral formation of a sealed portion 32 formed in a flat plate shape facing the up/down direction, an outer periphery surface portion 33 which protrudes downward from an outer periphery edge of the sealed portion 32, attachment portions 34, 34, . . . provided in an outer periphery portion of the sealed portion 32 spaced apart in the circumference direction, and a connection portion 35 provided in a central portion of the sealed portion 32.

The attachment portions 34, 34, . . . are provided protruding downward, and in the attachment portions 34, 34, . . . , screw holes 34a, 34a, . . . are formed which each open out in a downward direction.

The connection portion 35 is formed from a periphery-shaped portion 36, which is continuous with the sealed portion 32 and is formed in a substantially cylindrical shape, and a bottom surface portion 37 which is continuous with a lower end portion of the periphery-shaped portion 36.

The bottom surface portion 37 is provided in a state of being inclined by a predetermined angle α such as 3° relative to a horizontal direction H. In the bottom surface portion 37, a cable insertion hole 37a is formed in a central portion and screw insertion holes 37b and 37b are formed on both sides of the cable insertion hole 37a. The upper surface of the top surface of the bottom surface portion 37 is formed as an inclined surface 37c.

The placement base 25 and the cover 26 are connected by first attaching screws 500, 500, . . . which respectively pass through screw holes 28a, 28a, . . . being screwed into screw holes 34a, 34a, . . . .

The connector 23 is formed through the integral formation of an insertion alignment portion 38 formed in a substantially box shape which opens out in an upward direction and a joining portion 39 which protrudes downward from the insertion alignment portion 38 and where the outer shape is formed in a substantially cylindrical shape.

In the joining portion 39, an insertion hole 39a is formed in a central portion in the up/down direction, and attachment holes 39b and 39b which open out in a downward direction are formed on both sides of the insertion hole 39a. The lower surface of the joining portion 39 is formed as a sloping surface 39c inclined relative to the horizontal direction at, for example, 3°.

The connector 23 is connected to the support base 22 by second attaching screws 600, 600, . . . which respectively pass through the screw insertion holes 31b and 31b and the screw insertion holes 37b and 37b being screwed into the attachment holes 39b, 39b, . . . in a state where the joining portion 39 is inserted into the connection portion 35 of the cover 26 from above.

The main body 24 is, for example, formed in a cylindrical shape which is long in the up/down direction and is provided with sound output portions (not shown) in at least two side surfaces positioned on sides which are 180° opposite in the horizontal direction. In a lower end portion of the main body 24, an attachment concave portion 24a is provided which opens out in a downward direction.

The attachment concave portion 24a is inserted into the insertion alignment portion 38 and the main body 4 is attached to the connector 23 using an appropriate means such as pressure, adhering, or fixing by screws.

In a state where the speaker 21 is configured by the support base 22, the connector 23, and the main body 24 being connected as described above, one end of a cable is connected to a connection portion (not shown) of the main body 24, is passed through the insertion hole 39a of the connector 23, the cable insertion hole 37a of the support base 22, and the cable extraction hole 31a of the support base 22 in order, and the other end of the cable is led out to the outside and is connected to an external terminal of a television.

### Speaker Formation

In the speaker 21 configured in such a manner, the main body 24 is inclined in a state of either a first inclined state or a second inclined state according to an orientation whereby the joining portion 39 of the connector 23 is connected to the connection portion 35 of the support base 22.

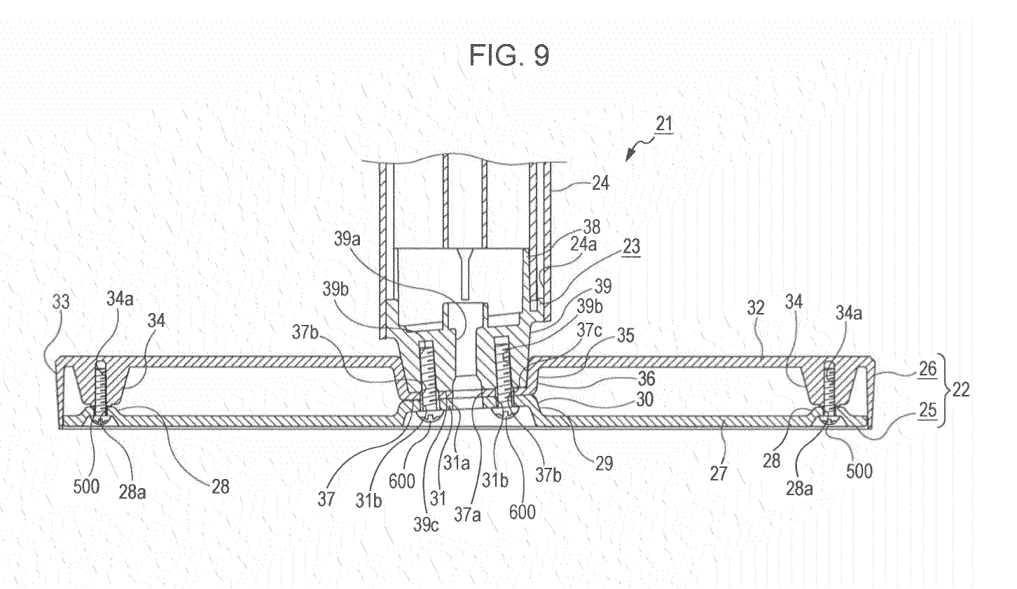

For example, when the connector 23 is attached to the support base 22 so that the inclined direction of the inclined surfaces 37c and 37c of the support base 22 and the inclined direction of the sloping surfaces 39c and 39c of the connector 23 are 180° in opposite directions relative to the horizontal direction, the first inclined state of the main body 24 is set and the main body 24 is in a state inclined by 0° relative to the vertical direction, that is, is in a vertical state (refer to FIG. 9).

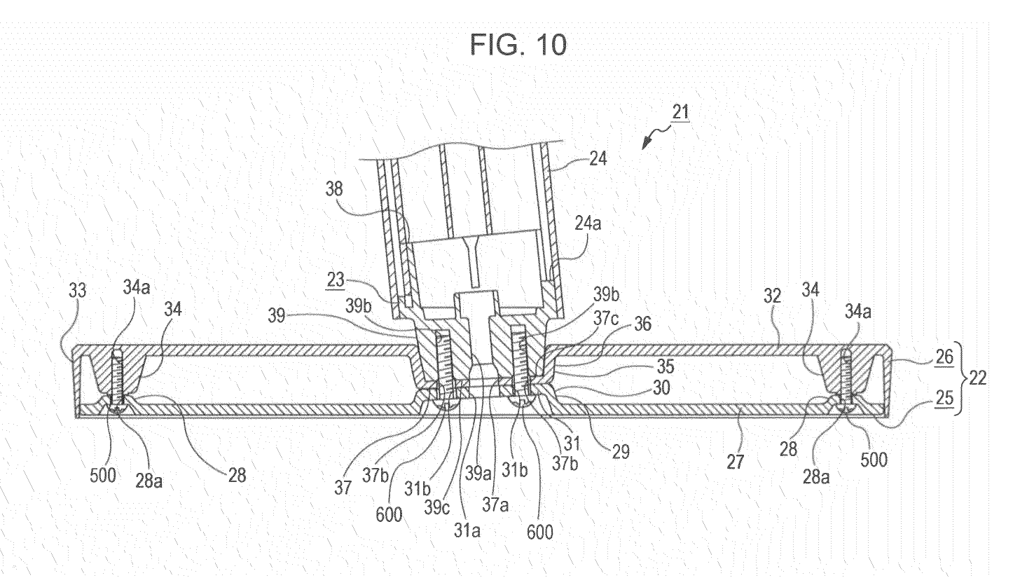

Additionally, when the connector 23 is attached to the support base 22 so that the inclined direction of the inclined surfaces 37c and 37c of the support base 22 and the inclined direction of the sloping surfaces 39c and 39c of the connector 23 are the same direction in the horizontal direction, the second inclined state of the main body 24 is set and the main body 24 is in a state inclined by 6° relative to the vertical direction (refer to FIG. 10).

In addition, the setting of the first inclined state or the second inclined state of the main body 24 of the speaker 21 is performed by temporarily loosening the second attaching screws 600 and 600, removing the connector 23 from the support base 22, changing the connector 23 to a predetermined orientation in relation to the support base 22, and again attaching the connector 23 to the support base 22 using the second attaching screws 600 and 600.

As described above, in the speaker 21, the main body 24 is inclined in a state of either the first inclined state or the second inclined state with different inclined angles relative to the vertical direction according to an orientation whereby the joining portion 39 of the connector 23 is connected to the connection portion 35 of the support base 22.

Accordingly, it is possible to secure a necessary inclined state of the main body 24 which is achieved with a simplified mechanism.

Additionally, since the inclined angle of the first inclined state is set to 0° where there is no inclination relative to the vertical direction, it is possible to secure a stable supporting state of the main body 24 in the first inclined state. Furthermore, by setting the inclined angle of the first inclined state to 0°, the angle, which is used as a standard relative to the vertical direction, is made clear.

In addition, in the description above, an example is shown where the inclined angle of the first inclined state relative to the vertical direction is set to 0° and the inclined angle of the second inclined state relative to the vertical direction is set to 6°. However, it is possible to set the inclined angles of the first inclined state and the second inclined state relative to the vertical direction to arbitrary angles other than 0° or 6°.

For example, it is possible to set the inclined angle of the inclined surfaces 37c and 37c of the support base 22 and the sloping surfaces 39c and 39c of the connector 23 relative to the horizontal direction to n° (where n° is an arbitrary number larger than 0), to set the first inclined state (0°) by setting the inclined direction of the inclined surfaces 37c and 37c and the inclined direction of the sloping surfaces 39c and 39c of the connector 23 as directions which are 180° in opposite directions relative to the horizontal direction, and to set the second inclined state (2n°) by setting the inclined direction of the inclined surfaces 37c and 37c and the sloping surfaces 39c and 39c as directions which are the same.

Additionally, in the speaker 21, the inclined state of the main body 24 is not limited to the two inclined states of the first inclined state and the second inclined state, it is possible to have a configuration where three or more inclined states are set according to the position of the connector 23 in relation to the support base 22.

In the speaker 21, by the joining portion 39 being connected to the connection portion 35 with an orientation whereby the inclined surfaces 37c and 37c of the support base 22 and the sloping surfaces 39c and 39c of the connector 23 come in contact in a state where the inclined directions are 180° in opposite directions relative to the horizontal direction, the main body 24 is inclined in the first inclined state.

Accordingly, a mechanism, which inclines the main body 24 in the first inclined state where the inclined angle is 0° relative to the vertical direction, is simple and it is possible to achieve a reduction in manufacturing costs due to the simplification of the mechanism.

All of the specific shapes and configurations of each portion shown as an optimal embodiment described above show but one specific example when the invention is applied and the technical scope of the invention is not to be interpreted as being limited by these.

The present application contains subject matter related to that disclosed in Japanese Priority Patent Application JP 2010-077729 filed in the Japan Patent Office on Mar. 30, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A speaker comprising:
a support base provided with a connection portion which has an inclined surface inclined at a predetermined angle relative to a horizontal direction;
a connector which has a sloping surface inclined at the same angle as the inclined surface of the support base relative to the horizontal direction and is provided with a joining portion connected to the connection portion of the support base in a state where the sloping surface comes into contact with the inclined surface; and
a main body which is attached to the connector and has a sound output portion,
wherein the main body is inclined in at least two states of a first inclined state and a second inclined state with different inclined angles relative to a vertical direction according to an orientation whereby the joining portion of the connector is connected to the connection portion of the support base.

2. The speaker according to claim 1,
wherein the joining portion of the connector is able to rotate in a horizontal direction in relation to the connection portion of the support base; and
the main body is inclined at different inclined angles according to a rotation position due to the rotation of the connector in relation to the support base in a state where the joining portion of the connector is connected to the connection portion of the support base.

3. The speaker according to claim 1,
wherein an inclined angle of the first inclined state is set to 0°.

4. The speaker according to claim 3,
wherein the joining portion is connected to the connection portion in an orientation whereby the inclined surface of the support base and the sloping surface of the connector come into contact in a state where the inclined directions are 180° in opposite directions in the horizontal direction, and the main body is inclined in the first inclined state.

5. The speaker according to claim 1,
wherein a lock concave portion is formed on one out of the connection portion of the support base and the joining portion of the connector and a lock protrusion portion which engages with the lock concave portion is provided on the other, and
the lock protrusion portion engages with the lock concave portion to lock the main body in the first inclined state or the second inclined state.
